(19) United States
(12) Patent Application Publication
(10) Pub. No.: US 2013/0346175 A1
(43) Pub. Date: Dec. 26, 2013

(54) PROMOTION (E.G., COUPON, GIFT CARD) REDEMPTION AFTER PURCHASE COMPLETION

(71) Applicant: Arunachalam Muthu, Fremont, CA (US)

(72) Inventor: Arunachalam Muthu, Fremont, CA (US)

(73) Assignee: eBay Inc., San Jose, CA (US)

(21) Appl. No.: 13/533,524

(22) Filed: Jun. 26, 2012

(51) Int. Cl. G06Q 30/02

(52) U.S. Cl. 705/14.23

(57) ABSTRACT

Methods and systems are provided for a user to redeem, even after a purchase (online or offline), any sort of promotional payment that may applied to a purchase, such as a coupon, gift card, reward, loyalty card, or other promotional payment or savings discount. The user may make payment to a merchant using a payment service. Many consumers forget to take a promotion—such as a coupon, gift card, loyalty card, or reward—to redeem at the time of purchase. Using the service, the consumer user may be able to redeem a promotion, e.g., coupon, for a purchase even after the purchase has been made, thus separating the purchase decision from the payment decision, and increasing user satisfaction. During the payment process using the service, the service provider may let the user decide which promotional payment (e.g., coupons, gift cards, rewards) to use, possibly subject to various limitations.

### BACKGROUND

1. Technical Field

Embodiments of the present invention generally relate to online commerce conducted over a communication network such as the Internet and, more particularly, to providing options for redeeming coupons and other purchase promotions after purchase using electronic payments.

2. Related Art

Shopping online, or electronically, has become more and more widely used, in part due to the ease with which a consumer can find items, pay, and complete a transaction without going to a seller's physical location. Such online shopping may be performed from a consumer's personal computer (PC) or laptop, for example, as well as, even more conveniently, from a mobile device, such as a smart phone. Thus, payment providers have developed payment products that enable the consumer to quickly, easily, and safely make an electronic payment for a purchase. Typical payment products do not, however, give the consumer much flexibility regarding payment terms and conditions. For example, today's bank payments immediately debit a user's bank account. Today's credit card payments allow a user to aggregate and “defer” the transfer of money from their bank account, but there are very strict and inflexible terms, fees, and payment schedules.

A common problem for the consumer when shopping is that the consumer may pay for an item using one of these payment products, but forget to apply, at the time of payment, a coupon, gift card, loyalty card, or other promotional payment or savings discount to the purchase. Thus, once the purchase is completed, the advantage of the promotional savings discount is lost to the shopper, even though the shopper could have validly applied the promotion, resulting in, at least, some annoyance if not pecuniary loss that may be considered substantial by the shopper.

### BRIEF DESCRIPTION OF THE DRAWINGS

FIG. 1 is a system diagram illustrating a system for applying promotional payments to purchases after purchase completion in accordance with one or more embodiments of the present invention.

FIG. 2 is a flow chart illustrating a method for applying promotional payments to purchases after purchase completion in accordance with an embodiment.

FIG. 3 is a flow chart illustrating a method for applying promotional payments to purchases after purchase completion in accordance with another embodiment.

Embodiments of the present disclosure and their advantages are best understood by referring to the detailed description that follows. It should be appreciated that like reference numerals are used to identify like elements illustrated in one or more of the figures, in which the showings therein are for purposes of illustrating the embodiments and not for purposes of limiting them.

### DETAILED DESCRIPTION

According to various embodiments, a consumer or user may redeem a coupon online with a payment applied to a purchase after the purchase (whether online or offline) is completed. In different embodiments, the coupon may be any sort of promotional payment that may applied to a purchase, such as a coupon, gift card, reward, loyalty card, or other promotion or savings discount. Embodiments may allow the user to decide which promotion (e.g., coupon, gift card, reward) the user wants to use for the transaction when the user completes the transaction (e.g., provides payment) or may let the user apply the promotional payment (e.g., coupon, gift card, reward) after the transaction is completed (e.g., on a previously completed transaction regardless of lapse of time so long as, for example, the promotion is still valid). In one or more embodiments, the user may complete the transaction (e.g., pay a merchant for the purchase) using a payment service that may be provided through a service provider, and the payment service may also allow the promotional payment to be applied to the transaction. According to one or more embodiments, the service provider or payment service may let the user decide, possibly subject to limitations, which promotional payment (e.g., coupons, gift cards, rewards) to use during the payment process. Such payment services may include, for example, an online payment service operating between consumers and merchants and may be a service provided by a financial service provider (FSP)—such as PayPal, Inc. of San Jose, Calif.—in which a user of the service may have an account with the FSP (referred to as an “FSP account). Another example of a payment service that may be provided by an FSP, such as PayPal, Inc., is disclosed in co-pending U.S. patent application Ser. No. 13/336,929, filed Dec. 23, 2011, entitled “Deferred Payment and Selective Funding and Payments”, which is incorporated by reference.

Embodiments may be useful to consumers by allowing a consumer to redeem a promotion, e.g., coupon, for a purchase even after the purchase has been made, in case the consumer has forgotten to take a promotion such as a coupon, gift card, loyalty card, or reward to redeem at the time of purchase, thus providing a cost savings to the consumer. Embodiments may be useful to service providers and merchants because separation of the purchase decision is from the payment decision for the consumer may allow promotions to succeed more frequently, thus increasing customer satisfaction and good will toward the businesses which are providing or benefiting from the promotions.

According to one or more embodiments, methods and systems are provided for a user to redeem, after a purchase (online or offline), any sort of promotional payment that may applied to a purchase, such as a coupon, gift card, reward, loyalty card, or other promotional payment or savings discount. In one or more embodiments, the consumer user may make payment to a merchant using a payment service that may be provided by a service provider. The payment service may allow the user to decide which promotion (e.g., coupon, gift card, reward) the user wants to use for the transaction when the user pays it off or may let the user apply the promotional payment (e.g., coupon, gift card, reward) on a previously completed transaction. From the consumer point of view, many consumers forget to take a promotion such as a coupon, gift card, loyalty card, or reward to redeem at the time of purchase. With the use of an embodiment, the consumer user may be able to redeem a promotion, e.g., coupon, for a purchase even after the purchase has been made. Embodiments may, thus, allow the user to feel happier or more satisfied, because the purchase decision is separated from the payment decision. During the payment process, with one or more embodiments, the service provider may let the user decide which promotional payment (e.g., coupons, gift cards, rewards) to use, possibly subject to various limitations.

In one or more embodiments, a method includes: providing a display of a transaction history of a user from a processor of a service provider to the user; receiving, by the processor, from the user a selection of a particular transaction shown in the transaction history; receiving, by the processor, a request from the user to apply a promotional payment to the selected particular transaction; sending, by the processor, a confirmation request regarding the promotional payment to a server processor of a merchant; receiving, by the processor, a confirmation response comprising an acceptance or a rejection of the promotional payment from the server processor of the merchant; in response to an acceptance, receiving a refund of the promotional payment from the merchant and providing the refund of the promotional payment to the user; and in response to a rejection, informing the user, from the processor, that the promotional payment is not accepted.

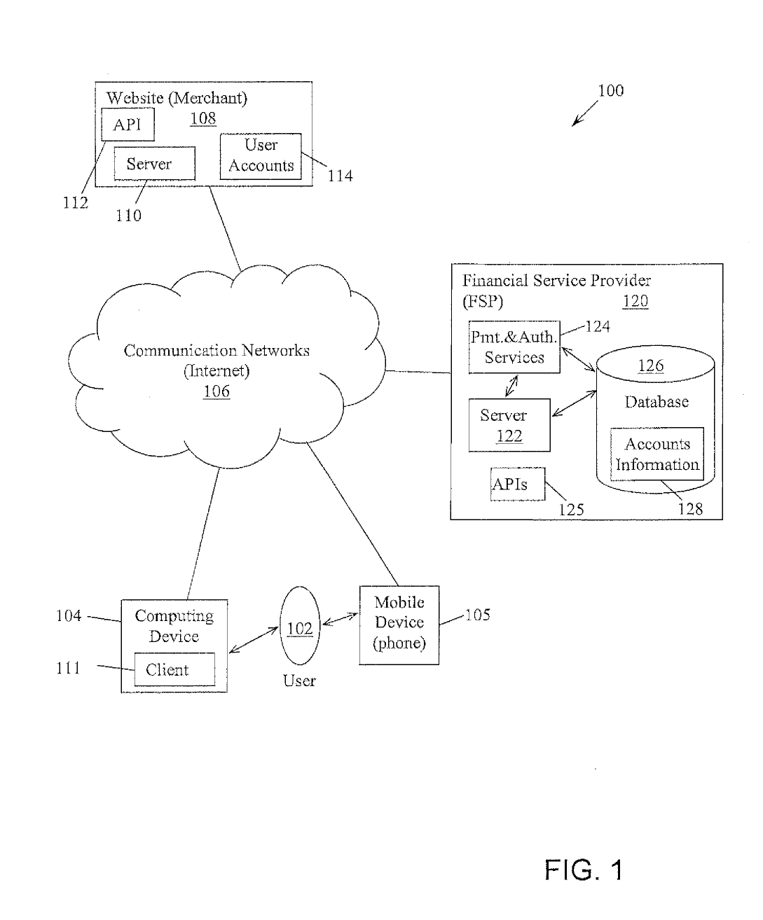

FIG. 1 illustrates a system 100 for online commerce according to one embodiment. A user 102 (generally a consumer or consumer user of FSP services) may communicate via a computing device 104 (e.g., a computer, cell phone, computing tablet, or other consumer electronic device) with financial service provider (FSP) 120 via communication network 106, which may be implemented as a single network or a combination of multiple networks. For example, network 106 may include the Internet as well as phone networks such as Public Switched Telephone Network (PSTN) or one or more intranets, landline networks, wireless networks, or other appropriate types of networks. User 102 may also communicate over communication network 106 using a mobile device 105, e.g., a mobile phone of any kind, that can receive messages such as Short Message Service (SMS) messages. In general, for purposes of embodiments described herein, computing device 104 and mobile device 105 need not be separate devices, although they can be, and may be the same device such as embodied by a smart phone, for example.

User 102 may also communicate via network 106 with a website 108 that may be a merchant website that is a seller of retail goods, for example. Merchant website 108 may sell goods online and may communicate with user 102, for example, by operating a server 110 (e.g., a computer processor) that presents a website for selling goods. The server 110 may respond to client devices (e.g., client 111 running on device 104) by communicating over network 106. Merchant website 108 may also maintain a database and provide user accounts 114 for its customers. A user account 114 may provide convenience for customers of the (e.g., merchant website 108) by allowing, for example, users to keep their shipping information on file with the merchant so as not to have to re-enter information with every order, or, for example, the merchant may like to offer promotions for users with an account 114 on merchant website 108.

Merchant website 108 may also communicate (for example, using server 110) with FSP 120 through FSP server 122 over network 106. For example, merchant website 108 may communicate with FSP 120 in the course of various services offered by FSP 120 to merchant website 108, such as payment intermediary between customers (e.g., consumer user 102) of merchant website 108 and merchant website 108 itself. For example, merchant website 108 may use an application programming interface (API) 112 that allows it to offer sale of goods in which customers are allowed to make payment through FSP 120, while consumer user 102 may have an account with FSP 120 that allows consumer user 102 to use the FSP 120 for making payments to sellers that allow use of authentication, authorization, and payment services 124 of FSP 120 as a payment intermediary. Also as shown in FIG. 1, FSP 120 may provide electronic data storage in the form of database 126. Database 126 may be used to keep track of user's accounts 128 with FSP 120, merchant's accounts with FSP 120, and transactions between customers, merchants, and stores including payments between the various entities, for example. FSP server 122 may execute various application programming interfaces (APIs) that may enable various different types of relationships between FSP 120 and the different parties shown in FIG. 1. In addition, FSP may provide various APIs 125 to its customers such as website 108 (e.g., API 112) that enable those websites to implement embodiments of authentication, authorization, and password reset services.

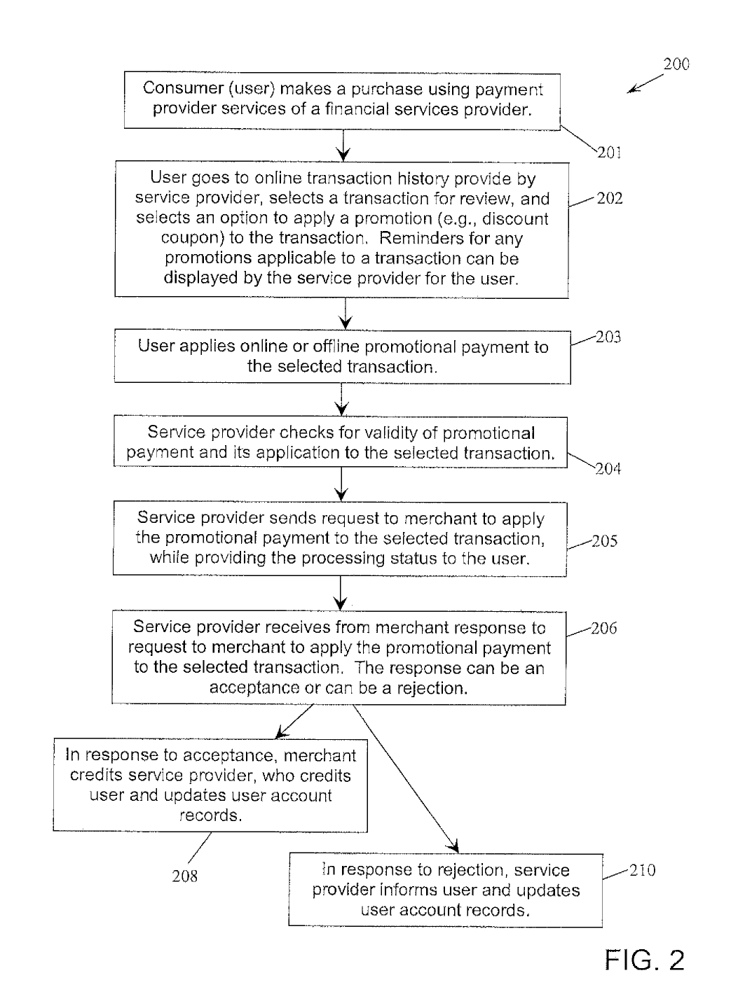

FIG. 2 illustrates a method 200 for applying promotional payments to purchases after purchase completion. In one embodiment, method 200 allows consumers to redeem, for example, a purchase coupon even after the purchase has been made without the coupon.

At step 201, a user (e.g., user 102) may make a purchase from a merchant. The purchase may be made online, such as on a merchant site (e.g., merchant website 108), or offline, such as at point of sale (POS) of a brick-and-mortar location. In either case, the purchase may be made using payment provider services (e.g. services 124) of FSP 120. For example, user 102 may use computing device 104 or mobile device 105 to communicate with FSP 120 whether the purchase is made at a POS or online at a merchant website 108, and likewise, FSP 120 may communicate with a participating merchant to provide payment services whether the purchase is made at a POS or online at a merchant website 108. The user may access the payment provider services 124 through a browser or mobile app/browser. The user may also access the payment provider services 124 through a merchant or payee device, such as at a POS. For an online checkout, the user may select a “checkout” button or link from a merchant site through the user's device. For an offline checkout, the user may select a suitable button or link on the user device or a merchant device, present the merchant with a payment instrument or user identifier, present the merchant with goods to scan, or use other suitable means.

The user 102 may pay for the purchase using the payment provider services 124 through an account the user has with FSP 120, and for which FSP 120 maintains account information 128 in a database 126. Account information 128 may include user information that may be used to identify the user, such as a user name, name, email address, phone number, IP address, or device ID. If the user has an account with the payment provider, the account information 128 may also include a password or PIN associated with the user account. Based on information received from user 102, FSP 120 may determine whether user 102 has an account with FSP 120. For example, FSP 120 may search account database 126 to see if the received user information corresponds to an active account. If no active account exists, FSP 120 may request the user to create an account, providing information such as a password or PIN, address, date of birth, email address, phone number, or information about a funding source, for example. Upon receipt of the requested information, FSP 120 may process the information, for example, to determine credit worthiness, including using information about the funding source, which typically is a credit card or bank account. After processing and analysis, a user account may be created for user 102, which may allow user 102 to make payments through the payment provider services 124. Thus, whether user 102 already has an account or one is created, user 102 may pay for the purchase through payment provider services 124 in a convenient manner. For example, user 102 may pay as usual by simply clicking on a browser or app button for some default method of payment that is already set up for the user's account with the payment provider services 124 of the FSP 120. In another example, user 102 may pay using a method for “Deferred Payment and Selective Funding and Payments” disclosed in U.S. patent application Ser. No. 13/336,929, referenced above.

Regardless of the type of payment made using payment provider services 124, the user also may use a valid coupon or other promotional payment to pay for the purchase. Moreover, FSP 120 may provide information for each user (e.g., as part of user accounts information 128) regarding various promotions and promotional payment instruments (such as coupons and loyalty cards, and rewards) the user has available to use for various kinds of transactions and purchases. FSP 120 may present such information to user 102 when user 102 accesses the user's account with FSP 120 by allowing the user 102 to select displays for and access a portion of the user's FSP account which may be referred to as the user's “wallet”. The user's wallet may be similar to a bank account in that the user's wallet with FSP 120 may allow the user to keep track of funds and other types of assets and credits (e.g., promotional payment instruments such as discount coupons) that are available for use by the user to apply to various transactions and purchases when using payment provider services 124. FSP 120 may aid each of its users with an account having a wallet by using the wallet to keep track of promotions, promotional payments, and promotional payment instruments available to the user. For example, if a user has a discount coupon available that is a one-time use coupon, availability for use by the user may be signified by the coupon being place “in” the user's wallet. Upon applying the one-time use coupon to a transaction, the one-time use coupon may no longer be valid for any transaction, so it is “removed” from the user's wallet, e.g., it is no longer displayed on the user's transaction history page as being available for use. Similarly, for example, a multi-use coupon, or promotional payment instrument, may be “left in” a user's wallet so long as it remains valid for application to other transactions. Thus, a user's wallet (e.g., wallet account) with FSP 120 may be used in a way that appears similar to a conventional wallet in conjunction, for example, with using payment provider services 124, and a user may use the wallet and payment provider services 124 to pay for purchases or transactions using various forms of payment such as credit, debit, and promotional payments such as coupons, rewards, gift cards, and loyalty cards, for example.

In the event, however, that the user may have forgotten to use a valid promotion (e.g., discount coupon, gift card, etc.) that the user may have had or, for example, that the user did not realize at the time of purchase was available, and could have been applied to the purchase, the user may wish that the promotional payment had been applied to the purchase. With the aid of one or more embodiments, the user need not regret the oversight. At step 202, a user 102 who has recently made and even completed (e.g., full payment has been tendered and accepted) a purchase or transaction, online or offline using payment provider services 124 of FSP 120, may log on or go online to the user's account with FSP 120. Once logged on with FSP 120 (e.g., logged on to payment provider services 124 via server 122) user 102 may go to the user's transaction history display for the user's account and select an option to apply a promotional payment to a particular transaction, regardless of whether the transaction has already been completed. For example, user 102, using mobile device 105 or computing device 104 may click on a tab of provider services 124 webpage for transaction history for the user's account, select a particular transaction (whether completed or not), and select an option such as “Apply Coupon/Gift Certificate/Loyalty Card” on the selected transaction.

In one embodiment, payment provider services 124 may keep track of what promotions or promotional payments are available to the user for each of the user's transactions shown on the transaction history display (e.g., page or tab) and provide a reminder display (e.g., on the transaction history page) when a promotion is available. For example, user 102 may select a recent transaction, e.g., a purchase, for review and a message may be displayed somewhere on the page (e.g., in a box, a frame, or using a pop-up) with information such as: “Reminder! It seems you forgot to apply your $2 coupon for this purchase, do you want to apply it now?” The reminder message could also supply an action button for the user to click, or the user could proceed to apply the coupon, if desired, as described, by selecting the particular transaction and selecting an apply promotional payment option for the selected transaction.

At step 203, the user 102 may have or know of a promotion (e.g., coupon, gift card, reward) that can be applied to one of the user's transactions shown on the user's transaction history display. The promotion may be, for example, one that is in the user's wallet with the service provider (e.g., FSP 120), one that the service provider has provided a reminder for when displaying information (e.g., transaction history) for the user's account or may be one for which the user has information from another or independent source, whether offline or online, such as a newspaper, printed magazine or other publication, or another website. Depending on the source (e.g., whether online or offline) for the promotion, the user 102 may click on a button to apply the online promotional payment to the selected transaction or, for example, type in or otherwise enter information to identify the offline promotion and promotional payment instrument and click on a button to confirm application of the identified promotional payment to the selected transaction.

At step 204, FSP 120 (e.g., payment provider services 124) may perform one or more validity checks on the promotional payment and its application to the selected transaction. For example, payment provider services 124 may check whether the promotional payment instrument is still within its validity time frame, e.g., whether a coupon has expired. Redemption of the promotional payment instrument (e.g., coupon) can occur at any time after the purchase is made, e.g., after checkout. There is a time, however, when the user can no longer redeem the promotional payment instrument (e.g., coupon). That time period may depend on various factors, including conditions of the purchase, time of the purchase, payment terms, available payment option changes, user account restrictions or limitations, or payment provider rules. So, for example, payment provider services 124 may check whether the promotional payment instrument can be applied to the particular transaction selected, e.g., whether application of a reward conforms to its applicable rules. Also, using a coupon as an example of a promotional payment instrument, payment provider services 124 may check whether the selected transaction has been performed within the coupon validity time frame. In case the promotional payment instrument is not valid or cannot be applied as wished by user 102, payment provider services 124 may so inform the user 102 and return the user to, for example, the transaction history display or page that the user was on. In case the promotional payment instrument is valid and can possibly be applied as wished by user 102, method 200 may continue at step 205.

At step 205, the service provider (e.g., FSP 120, payment provider services 124), may inform the user 102 by, for example, providing a message to computing device 104 or mobile device 105, that the service provider is processing the promotional payment redemption with the merchant with whom the selected transaction or purchase was transacted (e.g., merchant 108). The message may be provided concurrently with the validity checking performed by the service provider in step 205. Also concurrently, the service provider may send a request to the merchant through a real-time API to confirm the promotional payment instrument is valid and that the selected transaction is eligible to have the promotional payment applied to it. By real-time, it is meant that the user may expect to receive a communication within just a few seconds, up to perhaps a minute or so, whether the promotional payment has been applied or not to the selected transaction (e.g., whether the “forgotten” coupon has been applied to the purchase). In an alternative embodiment, the request to the merchant may be processed in batch mode, and the user may be sent a corresponding message when to expect a result and may be redirected back to the transaction history or other part of the service provider website.

At step 206, the service provider (e.g., FSP 120) may receive a response from the merchant (e.g., merchant 108) to the confirmation request from the service provider. The response from the merchant may comprise either an acceptance or rejection of the promotional payment or payment instrument as being applied to the selected transaction. If the response is an acceptance, method 200 may continue at step 208. If the response is a rejection, method 200 may continue at step 210.

At step 208, in response to acceptance, merchant credits service provider, who credits user and updates user account records. Using the case in which the promotional payment instrument is a coupon, for example, the merchant website 108 may refund the coupon reward amount to the service provider (e.g., FSP 120). Service provider, FSP 120, may then refund the coupon amount to the user 102. For example, FSP 120 may credit the user's FSP account balance, or may provide a credit directly to the funding source used (e.g., user's credit card) to pay for the transaction using the payment provider services 124. In case the service provider is keeping track of promotions used by and available to the user, as part of the user's FSP account services, the user's account records with regard to promotions could be updated. For example, when a coupon is only good for a single application to any purchase, coupon could be removed from the user's wallet, as described above. Similarly, for a gift card or reward, account records may be updated as to what amount is left available on the gift card, or reward points could be updated, as appropriate for the type of promotion and the promotional payment instrument.

At step 210, in response to rejection, service provider (e.g., FSP 120) informs user and updates user account records. In response to a rejection from the merchant 108, for example, payment provider services 124 may inform the user 102—for example, by a message displayed on computing device 104 or mobile device 105—that the chosen promotional payment for the selected transaction will not be applied by merchant 108. The service provider may then return the user to, for example, the transaction history display or a page that the user was on.

In the case of a merchant rejection, no refund may be given by the merchant 108, and no credit or refund may be passed on to the user 102 from the service provider (e.g., FSP 120). In case the service provider is keeping track of promotions used by and available to the user, as part of the user's FSP account services, the user's account records with regard to promotions could be updated. For example, the rejected promotional payment instrument could be marked as not being applicable to the type of transaction for which it was rejected although it may still be good for other transactions. Where a coupon that is only good for a single application to any purchase could be removed from the user's wallet, as described above, the rejected coupon may be considered unused and thus not removed from the user's wallet. Similarly, for gift cards or rewards, in response to no use having occurred, account records may not need to be updated (e.g., what amount is left available on the gift card, or reward points accumulated/used), as appropriate for the type of promotion and the promotional payment instrument.

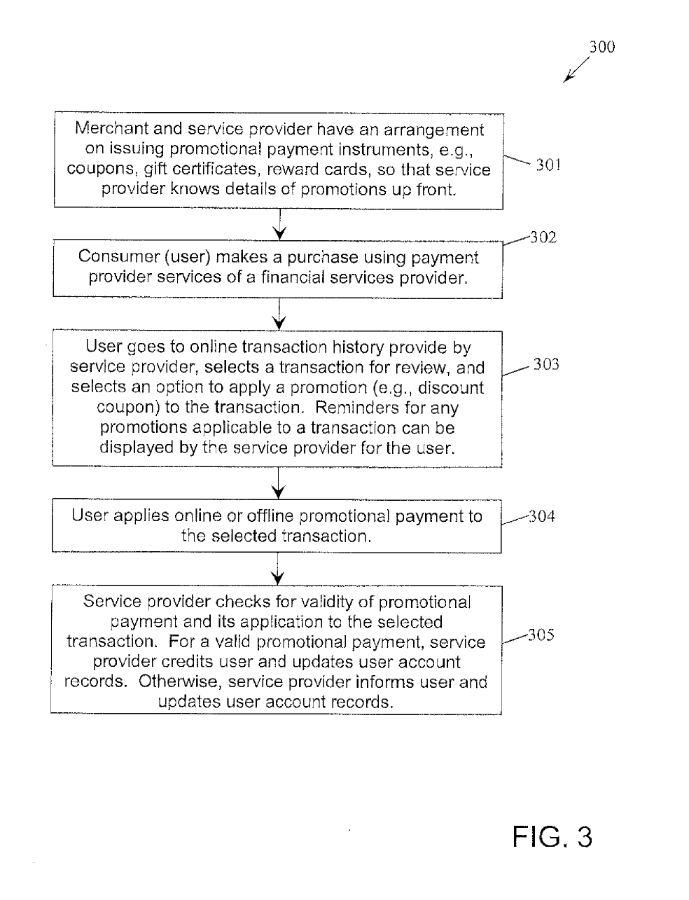

FIG. 3 illustrates a method 300 for method for applying promotional payments to purchases after purchase completion in accordance with another embodiment that allows consumers to redeem a purchase coupon, for example, even after the purchase has been made without the coupon.

At step 301, a merchant (e.g., merchant 108) may have an arrangement with a service provider (e.g., FSP 120) on issuing promotional payment instruments, e.g., coupons, gift certificates, reward cards, so that the service provider (e.g., payment provider services 124) knows, in advance, the details of any of the merchant's promotions for which a promotional payment will be available. Thus, when a user 102 makes a purchase and wishes to apply a promotional payment, the service provider may apply the promotional payment immediately after checking validity, without needing to make a confirmation request to the merchant as in step 205 of method 200.

At step 302, similar to step 201 of method 200, a user 102 makes a purchase from a merchant 108, whether online or offline, using, for example, payment provider services 124. User 102 may use a coupon or promotional payment for the purchase, or for whatever reason, there may be an oversight and an available promotion is not taken advantage immediately at the time of sale. At step 303, similar to step 202 of method 200, the user 102 may become aware of the oversight by checking at the service provider (e.g., FSP 120) website. At step 304, user 102 may apply the overlooked promotion to the purchase, similar to what is described for step 203 of method 200. At step 305, the service provider (e.g., payment provider services 124) may check the validity of the promotional payment, and because of the promotions arrangement with the merchant (e.g., merchant 108), the service provider can offer immediate (e.g., in real-time or within just a few seconds) redemption (or declination) of the promotional payment to the user's FSP account (similar to steps 208, 210 of method 200) without an intervening step of making a confirmation request to the merchant (similar, for example, to steps 205, 206 of method 200). In case there are any issues with redeeming the promotional payment, the service provider can contact the merchant to check again whether the promotional payment is valid or to resolve any issues.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In one embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

Logic may be encoded in a computer readable and executable medium, which may refer to any medium that participates in providing instructions to the processor for execution. Such a medium may take many forms, including but not limited to, non-volatile media, volatile media, and transmission media. In one embodiment, the computer readable medium is non-transitory. In various implementations, non-volatile media includes optical or magnetic disks, such as disk drive component, volatile media includes dynamic memory, such as system memory component, and transmission media includes coaxial cables, copper wire, and fiber optics, including wires that comprise bus. In one example, transmission media may take the form of acoustic or light waves, such as those generated during radio wave and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted to read.

In various embodiments, execution of instruction sequences for practicing the invention may be performed by a computer system. In various other embodiments, a plurality of computer systems coupled by a communication link (e.g., LAN, WLAN, PTSN, or various other wired or wireless networks) may perform instruction sequences to practice the invention in coordination with one another.

Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code, data, or both may be stored on one or more computer readable and executable mediums. It is also contemplated that software identified herein may be implemented using one or more general purpose or specific purpose computers or computer systems, networked or otherwise. Where applicable, the ordering of various steps described herein may be changed, combined into composite steps, or separated into sub-steps to provide features described herein.

The foregoing disclosure is not intended to limit the present invention to the precise forms or particular fields of use disclosed. It is contemplated that various alternate embodiments or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

What is claimed is:

1. A system comprising:
a processor configured to communication over a network with a mobile device and with a website; and
a data storage device including a computer-readable medium having computer readable code for instructing the processor, and when executed by the processor, the processor performs operations comprising:
providing a display of a transaction history of a user for the user;
receiving, by the processor, from the mobile device, a user selection of a particular transaction shown in the transaction history;
receiving, by the processor, a user request from the mobile device to apply a promotional payment to the selected particular transaction;
sending, by the processor, a confirmation request regarding the promotional payment to a server processor of a merchant;
receiving, by the processor, a confirmation response comprising an acceptance or a rejection of the promotional payment from the server processor of the merchant;
in response to an acceptance, receiving a refund of the promotional payment from the merchant and providing the refund of the promotional payment to the user; and
in response to a rejection, informing the user, from the processor, that the promotional payment is not accepted.

2. The system of claim 1, wherein providing the display comprises:
displaying a reminder regarding at least one transaction shown in the transaction history that has a promotion available for use.

3. The system of claim 1, wherein receiving the request comprises:
receiving a selection of a particular promotional payment displayed by the transaction history.

4. The system of claim 1, wherein receiving the request comprises:
receiving information from the user about a promotional payment to apply to the particular transaction.

5. The system of claim 1, wherein sending the confirmation request comprises:
checking a validity of the promotional payment for the selected particular transaction.

6. The system of claim 1, wherein the operations further comprise:
checking the request to apply the promotional payment to the selected particular transaction for validity;
in response to the request being valid, informing the user, from the processor, a message that redemption of the promotional payment is in process so that a display of the message is provided on a user device in real time; and wherein
sending the confirmation request occurs in real time, while the message is being displayed to the user.

7. The system of claim 1, wherein the particular transaction is one that has been completed.

8. A method comprising:
providing a display of a transaction history of a user from a processor of a service provider to the user;
receiving, by the processor, from the user a selection of a particular transaction shown in the transaction history;
receiving, by the processor, a request from the user to apply a promotional payment to the selected particular transaction;
sending, by the processor, a confirmation request regarding the promotional payment to a server processor of a merchant;
receiving, by the processor, a confirmation response comprising an acceptance or a rejection of the promotional payment from the server processor of the merchant;
in response to an acceptance, receiving a refund of the promotional payment from the merchant and providing the refund of the promotional payment to the user; and
in response to a rejection, informing the user, from the processor, that the promotional payment is not accepted.

9. The method of claim 8, wherein providing the display comprises:
displaying a reminder regarding at least one transaction shown in the transaction history that has a promotion available for use.

10. The method of claim 8, wherein receiving the request comprises:
receiving a selection of a particular promotional payment displayed by the transaction history.

11. The method of claim 8, wherein receiving the request comprises:
receiving information from the user about a promotional payment to apply to the particular transaction.

12. The method of claim 8, wherein sending the confirmation request comprises:
checking a validity of the promotional payment for the selected particular transaction.

13. The method of claim 8, further comprising:
checking the request to apply the promotional payment to the selected particular transaction for validity;
in response to the request being valid, informing the user, from the processor, a message that redemption of the promotional payment is in process so that a display of the message is provided on a user device in real time; and wherein
sending the confirmation request occurs in real time, while the message is being displayed to the user.

14. The method of claim 8, wherein the particular transaction is one that has been completed.

15. The method of claim 8, further comprising:
in response to an acceptance, removing a promotional payment instrument corresponding to the promotional payment from the user's wallet in case the promotional payment instrument is no longer valid.

16. The method of claim 8, further comprising:
in response to a rejection, leaving a promotional payment instrument corresponding to the promotional payment in the user's wallet in case the promotional payment instrument is still valid for other transactions.

17. A computer program product comprising a non-transitory computer readable medium having computer readable and executable code for instructing a processor to perform a method, the method comprising:
providing a display of a transaction history of a user from the processor to a user;
receiving, by the processor, from the user a selection of a particular transaction shown in the transaction history;
receiving, by the processor, a request from the user to apply a promotional payment to the selected particular transaction;
sending, by the processor, a confirmation request regarding the promotional payment to a server processor of a merchant;
receiving, by the processor, a confirmation response comprising an acceptance or a rejection of the promotional payment from the server processor of the merchant;
in response to an acceptance, receiving a refund of the promotional payment from the merchant and providing the refund of the promotional payment to the user; and
in response to a rejection, informing the user, from the processor, that the promotional payment is not accepted.

18. The computer program product of claim 17 wherein sending the confirmation request further comprises:
checking a validity of the promotional payment for the selected particular transaction.

19. The computer program product of claim 17 wherein the method further comprises:
checking the request from the user to apply the promotional payment to the selected particular transaction for validity;
in response to the request being valid, informing the user, from the processor, a message that redemption of the promotional payment is in process so that a display of the message is provided on a user device in real time; and wherein
sending the confirmation request occurs in real time, while the message is being displayed to the user.

20. The computer program product of claim 17 wherein the particular transaction is one that has been completed.
